(19) United States
(12) Patent Application Publication
(10) Pub. No.: US 2020/0015469 A1
(43) Pub. Date: Jan. 16, 2020

(54) FISHING TACKLE COMPACT STORAGE DEVICE

(71) Applicant: Jason Rich, Mississauga (CA)

(72) Inventor: Jason Rich, Mississauga (CA)

(21) Appl. No.: 16/032,137

(22) Filed: Jul. 11, 2018

(51) Int. Cl. A01K 97/06

(52) U.S. Cl. CPC A01K 97/06; B65D 73/0021

(57) ABSTRACT

A fishing tackle compact storage device may include a body which may be generally planar in shape. The body may have a first side edge, a second side edge, a first end edge, and a second end edge. One or more side slots may extend away from the first side edge and one or more second side slots may extend away from the second side edge. One or more first end slots may extend away from the first end edge and one or more second end slots may extend away from the second end edge. Preferably, one or more apertures may be positioned on the body between the first side edge and the second side edge. Portions of an object may be secured to the device by being inserted into or through one or more of the side slots, end slots, and/or apertures.

### FIELD OF THE INVENTION

This patent specification relates to the field of devices configured to store and organize objects. More specifically, this patent specification relates to a compact device configured to store and organize objects, such as fishing tackle.

### BACKGROUND

A wide variety of storage systems have been utilized to store and organize fishing tackle and equipment. It is common for fishing tackle to include one or more hooks with examples including lures having hook(s), bait having hook(s), jigs having hook(s), and leader lines attached to hook(s), and other tackle including swivels, clips, etc. It is also very common for fishermen and anglers to keep an assortment of different fishing tackle on hand to use in different fishing scenarios. Unfortunately, fishing tackle undoubtedly will become tangled together during transport which makes accessing a desired piece of tackle quite difficult. Much time and effort can be required in order to untangle the fishing tackle. This can be especially troublesome for an angler when a fishing scenario requires the rapid deployment of a desired piece of tackle. Additionally, due to the sharp hooks intrinsic to tackle, if care is not taken when handling and untangling tackle, an angler can easily injure their fingers on these hooks.

Therefore, a need exists for novel device configured to store and organize objects, such as fishing tackle. A further need exists for novel storage devices which have a small footprint and are able to compactly store one or more objects. There is also a need for novel storage devices which are configured to secure and sequester the hooks of fishing tackle. Finally, a need exists for novel storage devices which are configured to store and organize a wide variety of different types of fishing tackle.

### BRIEF SUMMARY OF THE INVENTION

A fishing tackle compact storage device is provided which may be used to store and organize objects, such as fishing tackle. In some embodiments, the device may include a body which may be generally planar in shape. The body may have a first side edge, a second side edge, a first end edge, and a second end edge. One or more side slots may extend away from the first side edge and one or more second side slots may extend away from the second side edge. One or more first end slots may extend away from the first end edge and one or more second end slots may extend away from the second end edge. Preferably, one or more apertures may be positioned on the body between the first side edge and the second side edge. Portions of an object may be secured to the device by being inserted into or through one or more of the side slots, end slots, and/or apertures.

In further embodiments, the device may include a first edge junction joining the first end edge to the first side edge, a second edge junction joining the first end edge to the second side edge, a third edge junction joining the second end edge to the second side edge, and a fourth edge junction joining the second end edge to the first side edge. Preferably, one or more edge junctions may have a side slot extending away from the respective edge junction.

In still further embodiments, the device may include an encasement having a cavity or interior into which a body securing an object such as fishing tackle may be placed. The encasement may be configured as a container into which the body and an object that it is securing may be placed and stored to prevent the object from interacting with other devices and their respective objects.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a top plan view of an example of a fishing tackle compact storage device according to various embodiments described herein.

FIG. 2 illustrates a bottom plan view of an example of a fishing tackle compact storage device according to various embodiments described herein.

FIG. 3 shows a side elevation view of an example of a fishing tackle compact storage device according to various embodiments described herein.

FIG. 4 depicts a bottom end elevation view of an example of a fishing tackle compact storage device according to various embodiments described herein

FIG. 5 illustrates a top plan view of an example of a fishing tackle compact storage device securing an item of fishing tackle according to various embodiments described herein.

FIG. 6 shows a bottom plan view of an example of a fishing tackle compact storage device securing an item of fishing tackle according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

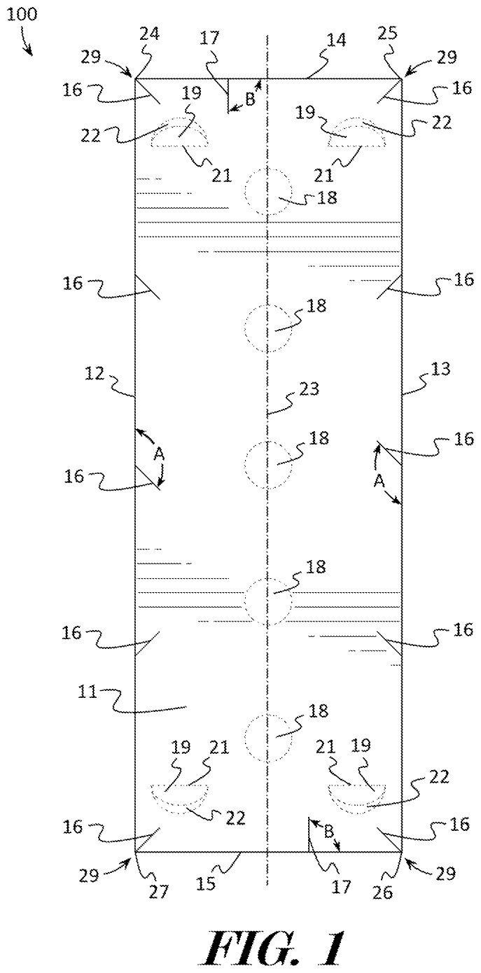

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new compact device configured to store and organize objects, such as fishing tackle, is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

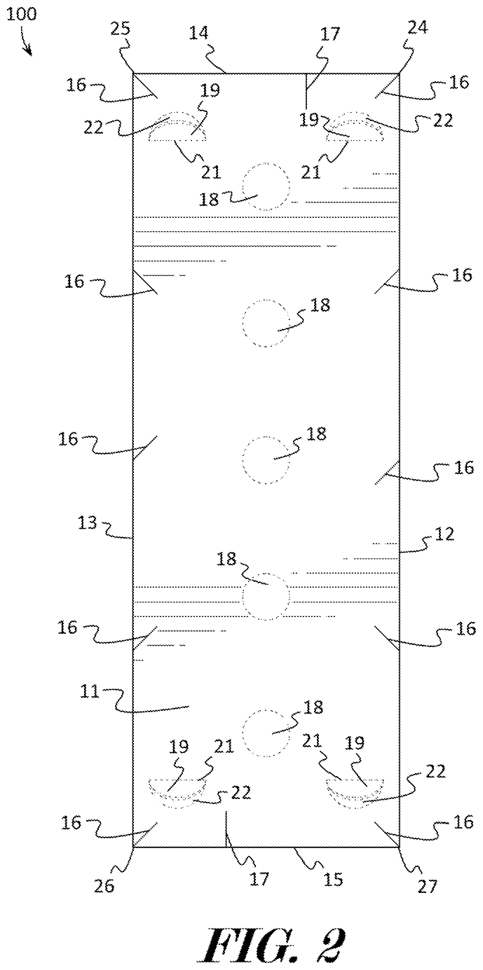

The present invention will now be described by example and through referencing the appended figures representing preferred and alternative embodiments. FIGS. 1-6 illustrate examples of a fishing tackle compact storage device (“the device”) 100 according to various embodiments. In some embodiments, the device 100 may comprise a body 11 which may be generally planar in shape. The body 11 may have a first side edge 12, a second side edge 13, a first end edge 14, and a second end edge 15. One or more side slots 16 may extend away from the first side edge 12 and one or more second side slots 16 may extend away from the second side edge 13. One or more first end slots 17 may extend away from the first end edge 14 and one or more second end slots 17 may extend away from the second end edge 15. Preferably, one or more apertures 18 may be positioned on the body 11 between the first side edge 12 and the second side edge 13.

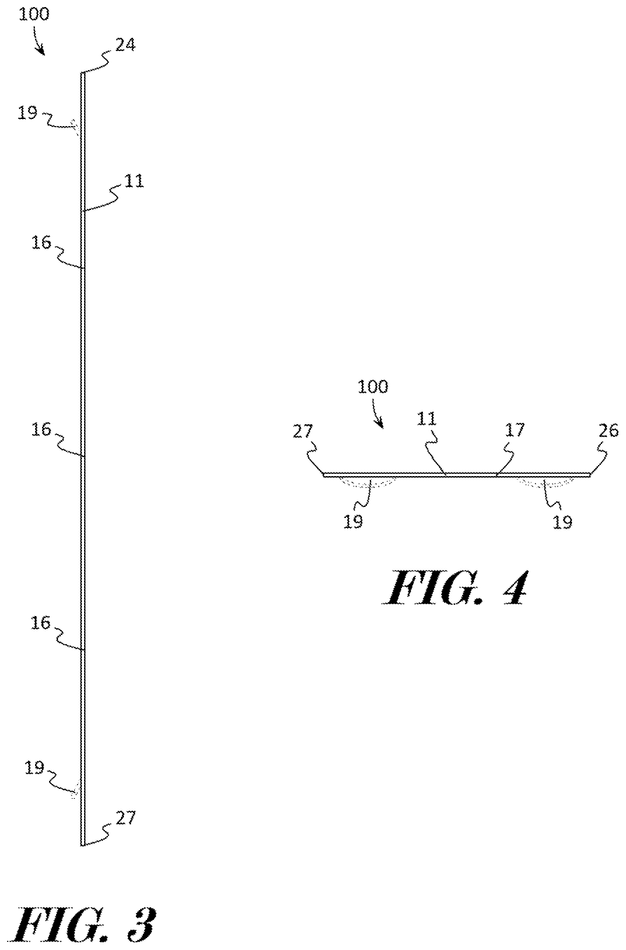

In preferred embodiments, the device 100 may comprise a body 11 that may be configured with a generally planar shape having a thickness (best shown in FIGS. 3 and 4) which may be substantially less than length and width dimensions (best shown in FIGS. 1, 2, 5, and 6). In other embodiments, the device 100 may comprise a body 11 that may be configured with a generally rectangular prism shape, cylindrical shape, or any other shape. In further preferred embodiments, the body 11 may comprise a generally planar and rectangular shape having side edges 12, 13, being generally parallel to each other, end edges 14, 15, being generally parallel to each other, and the side edges 12, 13, being generally perpendicular to the end edges 14, 15. In still further embodiments, the body 11 may be configured with side edges 12, 13, being approximately between 5.0 and 9.0 inches, and more preferably approximately 7.25 inches, in length and with end edges 14, 15, being approximately between 1.0 and 4.0 inches, and more preferably approximately 2.5 inches, in length.

In some embodiments, a side edge 12, 13, may be generally straight or linear. In other embodiments, a side edge 12, 13, may comprise a curved shape, such as a convex curve shape extending away from the body or a concave curve shape extending towards the body 11. In other embodiments, a side edge 12, 13, may comprise a saw tooth shape, a scalloped shape, or any other shape including combinations of shapes. Likewise, in some embodiments, an end edge 14, 15, may be generally straight or linear. In other embodiments, an end edge 14, 15, may comprise a curved shape, such as a convex curve shape extending away from the body or a concave curve shape extending towards the body 11. In other embodiments, an end edge 14, 15, may comprise a saw tooth shape, a scalloped shape, or any other shape including combinations of shapes. While in some embodiments, a side edge 12, 13, may be generally parallel to another side edge 12, 13, and generally perpendicular to an end edge 14, 15, in other embodiments, one or more side edges 12, 13, and/or end edges 14, 15, may be angled relative to each other. For example, the body 11 may be configured with a trapezoid shape, a parallelogram shape, or any other shape.

In some embodiments, a side edge 12, 13, may be joined to an end edge 14, 15, via an edge junction 24, 25, 26, 27. Generally, an edge junction 24, 25, 26, 27, may form the intersection at which a side edge 12, 13, and an end edge 14, 15, come together. In preferred embodiments, the body 11 may comprise a first edge junction 24 joining the first end edge 14 to the first side edge 12, a second edge junction 25 joining the first end edge 14 to the second side edge 13, a third edge junction 26 joining the second end edge 15 to the second side edge 13, and a fourth edge junction 27 joining the second end edge 15 to the first side edge 12.

In some embodiments, one or more edge junctions 24, 25, 26, 27, may be configured with a rounded shape 28. In preferred embodiments, one or more edge junctions 24, 25, 26, 27, may be configured with an angled shape 29 (FIG. 1). In further embodiments, one or more edge junctions 24, 25, 26, 27, may be configured with an angled shape 29 of between 45 and 135 degrees. For example, the first end edge 14 may intersect the first side edge 12 at a first edge junction 24 having an angled shape 29 of between 45 and 135 degrees. In still further embodiments, one or more edge junctions 24, 25, 26, 27, may be configured with an angled shape 29 of substantially 90 degrees. For example, the second end edge 15 may intersect the second side edge 13 at a third edge junction 26 having an angled shape 29 of substantially 90 degrees.

In some embodiments, the device 100 may comprise a first tab 19 positioned on the body 11 proximate to the first edge junction 24, a second tab 19 positioned on the body 11 proximate to the second edge junction 25, a third tab 19 positioned on the body 11 proximate to the third edge junction 26, and a fourth tab 19 positioned on the body 11 proximate to the fourth edge junction 27. In further embodiments, one or more edge junctions 24, 25, 26, 27, may comprise a side slot 16. In further preferred embodiments, each edge junction 24, 25, 26, 27, may comprise a side slot 16 so that a side slot 16 may be extending away from the first edge junction 24, a side slot 16 may be extending away from the second edge junction 25, a side slot 16 may be extending away from the third edge junction 26, and a side slot may be extending away from the fourth edge junction 27.

The body 11 may be made from or may comprise any material that may be suitable for contact with moisture and preferably water proof. In some embodiments, the body 11 may be made from or may comprise a durable and flexible material such as water proof paper board, a natural and/or synthetic rubber material such as latex rubber, forms of the organic compound isoprene, Polyacrylate Rubber, Ethylene-acrylate Rubber, Polyester Urethane, a flexible plastic such as high-density polyethylene (HDPE), polyvinyl chloride (PVC), polypropylene (PP), Polystyrene (PS), Polycarbonate (PC), low density polyethylene (LDPE), carbon fiber, or any other flexible or slightly flexible material. In still further embodiments, the body 11 may be made from or may comprise a durable and flexible material such as a thin sheet of aluminum, copper, or any other metal or metal alloy which may be suitable for contact with moisture and preferably corrosion resistant.

In some embodiments, the device 100 may comprise one or more side slots 16 which may be positioned anywhere on the body 11. In preferred embodiments, the device 100 may comprise one or more side slots 16 which may be positioned on one or both side edges 12, 13. Generally, a side slot 16 may comprise a channel or opening which may extend through the body 11. For example, a side slot 16 may comprise a slit or cut in the body 11. In some embodiments, a side slot 16 may be shaped to receive narrow objects, such as fishing line, fishing leader, fishing hooks, etc. In preferred embodiments, a side slot 16 may be shaped to frictionally retain narrow objects, such as fishing line, fishing leader, fishing hooks, etc. For example, a side slot 16 may comprise a cut in a body 11 formed of water proof paper board that may be smaller than the width of common types of fishing line so that when fishing line is pressed into the side slot 16, the fishing line may be frictionally retained in the side slot 16. A side slot 16 may be configured with a generally linear shape, a curved shape, or any other shape including combinations of shapes. In some embodiments, a side slot 16 may comprise a length of approximately between 0.375 and 0.625 inches. In further embodiments, a side slot 16 may comprise a width of approximately between 0.1 and 5 millimeters.

In some embodiments, the device 100 may comprise one or more, such as six, side slots 16 extending away from the first side edge 12 and one or more, such as six, side slots 16 extending away from the second side edge 13. For example, the device 100 may comprise a first side slot 16 extending away from the first side edge 12 and a second side slot 16 extending away from the second side edge 13. In further embodiments, a side slot 16 may extend generally perpendicularly away from a side edge 12, 13.

In preferred embodiments, a side slot 16 may be angled relative to a side edge 12, 13, as shown by Angles A in FIG. 1. In some embodiments, a side slot 16 may be angled approximately between 25 and 165 degrees relative to a side edge 12, 13, so that Angle A for the side slot 16 may be approximately between 25 and 165 degrees. In preferred embodiments, a side edge 12, 13, may comprise two or more side slots 16 which may be angled relative to a side edge 12, 13, and each side slot 16 may also be angled towards the end edge 14, 15, that the respective side slot 16 is furthest from as shown by Angles A in FIG. 1. For example, a side slot 16 that is relatively closer to the second edge 15 than the first edge 14 may comprise an Angle A that is greater than 90 degrees so that the side slot 16 is angled towards the first edge 14.

In some embodiments, the device 100 may comprise one or more end slots 17 which may be positioned anywhere on the body 11. In preferred embodiments, the device 100 may comprise one or more end slots 17 which may be positioned on one or both end edges 14, 15. Generally, an end slot 17 may comprise a channel or opening which may extend through the body 11. For example, an end slot 17 may comprise a slit or cut in the body 11. In some embodiments, an end slot 17 may be shaped to receive narrow objects, such as fishing line, fishing leader, fishing hooks, etc. In preferred embodiments, an end slot 17 may be shaped to frictionally retain narrow objects, such as fishing line, fishing leader, fishing hooks, etc. For example, an end slot 17 may comprise a cut in a body 11 formed of a sheet of PVC plastic that may be smaller than the width of common types of fishing line so that when fishing line is pressed into the end slot 17, the fishing line may be frictionally retained in the end slot 17. An end slot 17 may be configured with a generally linear shape, a curved shape, or any other shape including combinations of shapes. In some embodiments, an end slot 17 may comprise a length of approximately between 0.375 and 0.625 inches. In further embodiments, an end slot 17 may comprise a width of approximately between 0.1 and 5 millimeters.

In some embodiments, the device 100 may comprise one or more end slots 17 extending away from the first end edge 14 and one or more end slots 17 extending away from the second end edge 15. For example, the device 100 may comprise a first end slot 17 extending away from the first end edge 14 and a second end slot 17 extending away from the second end edge 15. In further embodiments, a side slot 16 may extend generally perpendicularly away from a side edge 12, 13.

In preferred embodiments, an end slot 17 may be generally perpendicular to the end edge 14, 15, that the end slot 17 is extending away from as shown by Angles B in FIG. 1. In some embodiments, an end slot 17 may be generally perpendicular and angled approximately between 85 and 95 degrees relative to the end edge 14, 15, that the end slot 17 is extending away from, so that Angle B for the end slot 17 may be approximately between 85 and 95 degrees. In alternative embodiments, an end slot 17 may be angled approximately between 25 and 165 degrees relative to the end edge 14, 15, that the end slot 17 is extending away from, so that Angle B for the end slot 17 may be approximately between 25 and 165 degrees.

In some embodiments, the device 100 may comprise one or more tabs 19. Generally, a tab 19 may comprise a flap that may be movably coupled to the body 11 via a hinge 21 so that portions of the tab 19 that are distal to the hinge 21 may be movable towards and away from the body 11. A tab 19 may be configured in any shape and size, such as a semi-circular or hemi-circular shape depicted in FIGS. 1, 2, 5, and 6. In preferred embodiments, a tab 19 may be movably coupled to the body 11 via a hinge 21 configured as a living hinge, which typically comprises a linear, relatively flexible area between two relatively more rigid components, such as a line of thin plastic or flexible material between thicker or more rigid portions, as is well known in the art. In further preferred embodiments, a tab 19 may be formed via a tab cut 22 which may define the shape of the tab 19 by separating portions of the tab 19 from the body 11 so that a living hinge type hinge 21 of approximately between 0.375 and 0.625 inches in length may be formed between opposing ends of the tab cut 22. In other embodiments, a hinged coupling 33 may comprise a butt hinge, piano hinge, barrel hinge, case hinge, flag hinge, strap hinge, or any other type or style of hinge which may enable a tab 19 to be movably coupled to the body 11.

One or more tabs 19 may be positioned anywhere on the device 100. In some embodiments, a first tab 19 may be positioned on the body 11 proximate to the first end edge 14 and a second tab 19 may be positioned on the body 11 proximate to the second end edge 15. Optionally, the hinge 21 of a first tab 19 that may be positioned on the body 11 proximate to the first end edge 14 may be oriented towards the hinge 21 of a second tab 19 that may be positioned on the body 11 proximate to the second end edge 15 and the hinge 21 of the second tab 19 may likewise be oriented towards the hinge 21 of the first tab 19. In further embodiments, the device 100 may comprise a central axis 23 (FIG. 1) which may generally bisect the device 100 between the first side edge 12 and the second side edge 13. Preferably, two tabs 19 may be positioned on the body 11 proximate to the first end edge 14 on opposing sides of the central axis 23 and two tabs 19 may be positioned on the body 11 proximate to the second end edge 15 on opposing sides of the central axis 23.

In some embodiments, the device 100 may comprise one or more, such as seven apertures 18 which may be positioned anywhere on the body 11. An aperture 18 may comprise an opening that extends through the body 11 and may be configured in any size and shape. In preferred embodiments, an aperture 18 may comprise a generally circular shape, while in other embodiments, an aperture 18 may comprise a generally rectangular shape, oval shape, triangular shape, or any other shape including combinations of shapes. In further preferred embodiments, an aperture 18 may comprise an opening with a minimum dimension of approximately between 0.375 and 0.625 inches. For example, an aperture 18 may comprise generally circular opening with a diameter of approximately between 0.375 and 0.625 inches. In further embodiments, the device 100 may comprise a central axis 23 which may generally bisect the device 100 between the first side edge 12 and the second side edge 13. Preferably, two or more, and more preferably all, apertures 18 of the device 100 may be aligned with the central axis 23 so that the two or more apertures 18 may be approximately bisected by the central axis 23.

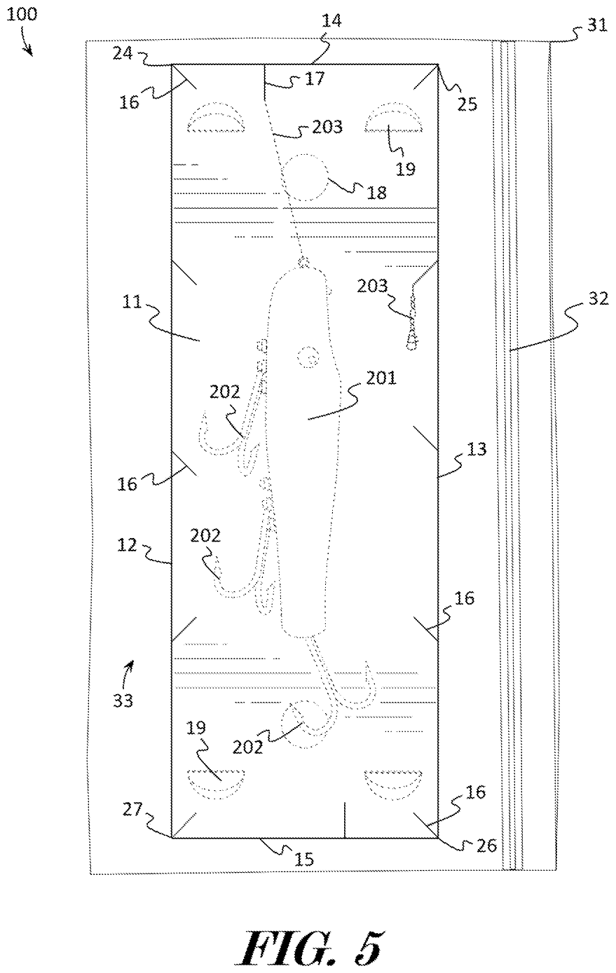

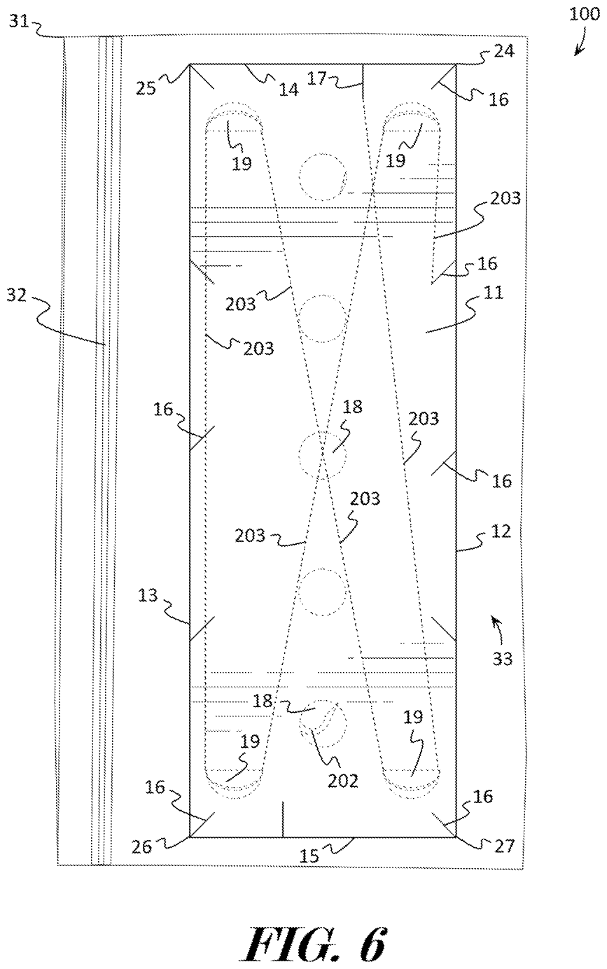

As perhaps best shown in FIGS. 5 and 6, the device 100 may be used to store and organize objects, such as fishing tackle 201. For example, the device 100 may be used to store a fishing lure type of fishing tackle 201 having one or more hooks 202 and a leader 203. The fishing tackle 201 may be placed in contact with the body 11 and one or more hooks 202 may be placed in one or more of the apertures 18. The leader 203 may be wrapped around the body 11 and secured thereto by placing the leader 203 within one or more slots 16, 17. The leader 203 may also be secured to the body 11 by wrapping the leader 203 around one or more tabs 19.

In preferred embodiments, the device 100 may comprise an encasement 31 having a cavity 33 or interior into which a body 11 securing an object such as fishing tackle 201 may be placed. Generally, an encasement 31 may be configured as a container into which the body 11 and an object that it is securing may be placed and stored to prevent the object from interacting with other devices 100 and their respective objects. In some embodiments, an encasement 31 may be made from or comprise a flexible material and be configured as a plastic bag. A flexible material may include plastics, such as High-Density Polyethylene (HDPE), Low Density Polyethylene (LDPE), Linear Low-Density Polyethylene (LLDPE), Medium Density Polyethylene (MDPE), Polypropylene (PP), natural and synthetic rubbers, such as silicone, canvas and other types of fabric, or any other flexible material. In other embodiments, an encasement 31 may be made from or comprise a generally rigid material and be configured as a rigid container. Generally rigid materials may include aluminum, steel, other metals and metal alloys, wood, hard rubbers, hard plastics, fiber reinforced plastics, carbon fiber, fiber glass, resins, polymers or any other suitable materials including combinations of materials. In preferred embodiments, an encasement 31 may comprise a fastener 32 which may govern access to the interior or cavity 33 of the encasement 31 to allow or prevent the body 11 and an object secured thereto from being inserted into or removed from the encasement 31. A fastener 32 may comprise a tongue and groove press fit fastener, a magnetic fastener, hook and loop type fastener, a latch type fastener, an elastic or resilient fastener, or any other type of fastener which may be configured to govern access to the interior of the encasement 31.

While some exemplary shapes and sizes have been provided for elements of the device 100, it should be understood to one of ordinary skill in the art that the body 11, side slots 16, end slots 17, apertures 18, tabs 19, edge junctions 24, 25, 26, 27, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from or may comprise durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A fishing tackle compact storage device, the device comprising:
a body having a first side edge, a second side edge, a first end edge, and a second end edge;
a first side slot extending away from the first side edge and a second side slot extending away from the second side edge;
a first end slot extending away from the first end edge and a second end slot extending away from the second end edge; and
a first aperture positioned on the body between the first side edge and the second side edge.

2. The device of claim 1, further comprising at least one tab.

3. The device of claim 2, comprising a first tab positioned on the body proximate to the first end edge, and comprising a second tab positioned on the body proximate to the second end edge.

4. The device of claim 1, further comprising a central axis, and further comprising two or more apertures aligned with the central axis.

5. The device of claim 1, wherein the first side slot is angled relative to the first side edge, and wherein the second side slot is angled relative to the second side edge.

6. The device of claim 1, wherein the first end slot is generally perpendicular to the first end edge, and wherein the second end slot is generally perpendicular to the second end edge.

7. The device of claim 1, further comprising: a first edge junction joining the first end edge to the first side edge, a second edge junction joining the first end edge to the second side edge, a third edge junction joining the second end edge to the second side edge, and a fourth edge junction joining the second end edge to the first side edge.

8. The device of claim 7, wherein an edge junction selected from the group consisting of the first edge junction, second edge junction, third edge junction, and fourth edge junction comprises an angled shape of between 45 and 135 degrees.

9. The device of claim 7, wherein the first edge junction, second edge junction, third edge junction, and fourth edge junction each comprise an angled shape of substantially 90 degrees.

10. The device of claim 7, comprising a first tab positioned on the body proximate to the first edge junction, a second tab positioned on the body proximate to the second edge junction, a third tab positioned on the body proximate to the third edge junction, and a fourth tab positioned on the body proximate to the fourth edge junction.

11. The device of claim 1, further comprising an encasement.

12. A fishing tackle compact storage device, the device comprising:
a generally planar body having a first side edge, a second side edge, a first end edge, a second end edge, a first edge junction joining the first end edge to the first side edge, a second edge junction joining the first end edge to the second side edge, a third edge junction joining the second end edge to the second side edge, and a fourth edge junction joining the second end edge to the first side edge;
a first side slot extending away from the first side edge, a second side slot extending away from the second side edge, a third side slot extending away from the first edge junction, a fourth side slot extending away from the second edge junction, a fifth side slot extending away from the third edge junction, and a sixth side slot extending away from the fourth edge junction;
a first end slot extending away from the first end edge and a second end slot extending away from the second end edge; and
a first aperture positioned on the body between the first side edge and the second side edge.

13. The device of claim 12, further comprising at least one tab.

14. The device of claim 13, comprising a first tab positioned on the body proximate to the first end edge, and comprising a second tab positioned on the body proximate to the second end edge.

15. The device of claim 12, further comprising a central axis, and further comprising two or more apertures aligned with the central axis.

16. The device of claim 12, wherein the first side slot is angled relative to the first side edge, and wherein the second side slot is angled relative to the second side edge.

17. The device of claim 12, wherein the first end slot is substantially perpendicular to the first end edge, and wherein the second end slot is substantially perpendicular to the second end edge.

18. The device of claim 12, wherein an edge junction selected from the group consisting of the first edge junction, second edge junction, third edge junction, and fourth edge junction comprises an angled shape of between 45 and 135 degrees.

19. The device of claim 12, wherein the first edge junction, second edge junction, third edge junction, and fourth edge junction each comprise an angled shape of substantially 90 degrees.

20. The device of claim 12, comprising a first tab positioned on the body proximate to the first edge junction, a second tab positioned on the body proximate to the second edge junction, a third tab positioned on the body proximate to the third edge junction, and a fourth tab positioned on the body proximate to the fourth edge junction.
